(19) United States
(12) Patent Application Publication
(10) Pub. No.: US 2009/0103885 A1
(43) Pub. Date: Apr. 23, 2009

(54) MOVING IMAGE REPRODUCING APPARATUS AND PROCESSING METHOD THEREFOR

(75) Inventors: Reiko Fujino, Kawasaki-shi (JP); Susumu Igarashi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/250,064

(22) Filed: Oct. 13, 2008

(30) Foreign Application Priority Data
Oct. 15, 2007 (JP) 2007-267997

(51) Int. Cl. H04N 5/91; H04N 5/76

(52) U.S. Cl. 386/46; 348/231.99; 386/E05.001; 348/E05.022

(57) ABSTRACT

A moving image reproducing apparatus of the present invention transfers moving image data stored in a built-in memory to an external storage device in order starting from moving image data corresponding to a sequence having a short total reproduction time, the sequence being reproduced by a reproduction control unit.

### BACKGROUND OF THE INVENTION

1. Field of the Invention

The present invention relates to a method for processing moving image data reproduced by a moving image reproducing apparatus.

2. Description of the Related Art

In the related art, image transmitting apparatuses configured to transfer image data captured using digital cameras or camera-equipped mobile phones having a communication function to image storage servers over public lines have been available (see Japanese Patent Laid-Open No. 11-146224). In such apparatuses, when a memory of the digital cameras or camera-equipped mobile phones is completely full of stored image data, the stored image data may be transferred to the servers to increase the remaining capacity of the memory.

In general, image reproducing apparatuses are configured to, when a user wishes to reproduce image data, download the image data from a storage device via a network. Since the amount of moving image data is significantly greater than the amount of still image data, it is difficult to currently reserve a sufficient amount of communication bandwidth to allow downloading, and a large amount of time is required. Moving image data may be stored in an internal memory of the image reproducing apparatuses. However, there is a limit to the capacity of such a memory.

### SUMMARY OF THE INVENTION

The present invention provides a moving image reproducing apparatus capable of quickly reproducing moving image data.

The present invention further provides an image reproducing apparatus capable of reducing the amount of communication data to smoothly reproduce moving image data.

In an embodiment of the present invention, a moving image reproducing apparatus includes a reproduction control unit configured to control reproduction of image data stored in a memory; and a transfer unit configured to transfer image data corresponding to a sequence having a short total reproduction time to an external storage device, the sequence being reproduced by the reproduction control unit.

Other features of the present invention will become apparent from the following description in conjunction with the drawings.

### BRIEF DESCRIPTION OF THE DRAWINGS

FIG. 1 is a block diagram of an example image pickup apparatus, which is an image reproducing apparatus according to a first embodiment of the present invention.

FIG. 2 is a flowchart showing a moving image data transfer process of a storage control unit according to the first embodiment.

FIG. 3 is a block diagram of a system according to the first embodiment of the present invention.

FIG. 4 is a flowchart showing a reproduction process of a reproduction control unit according to the first embodiment.

FIG. 5 is a table storing group-of-pictures (GOP) head position information.

FIG. 6 is a diagram showing an example of pictures in the H.264 coding scheme, which correspond to GOPs.

FIG. 7 is a diagram showing a structure of encoded moving image data.

### DESCRIPTION OF THE EMBODIMENTS

Embodiments of the present invention will now herein be described below.

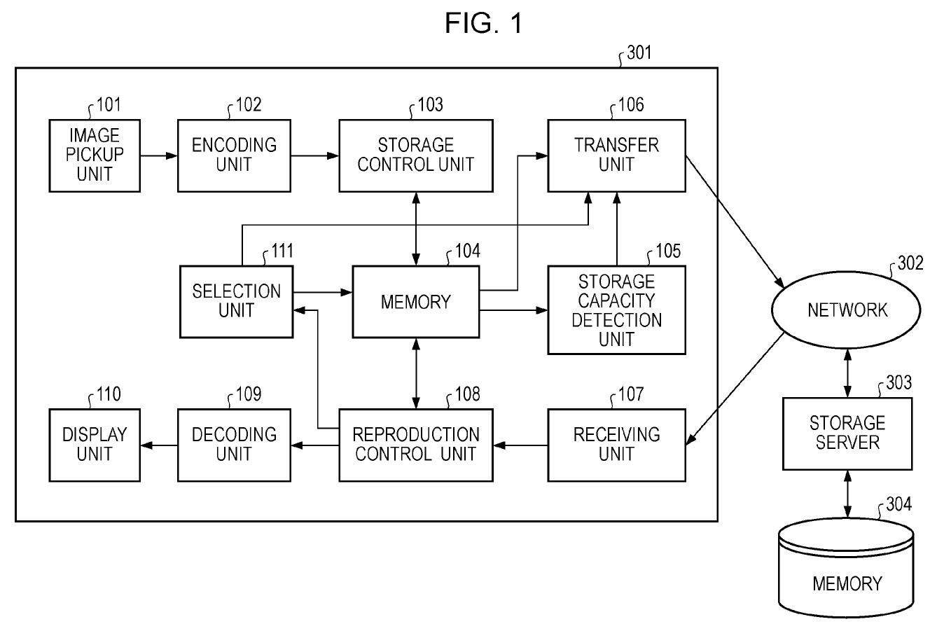

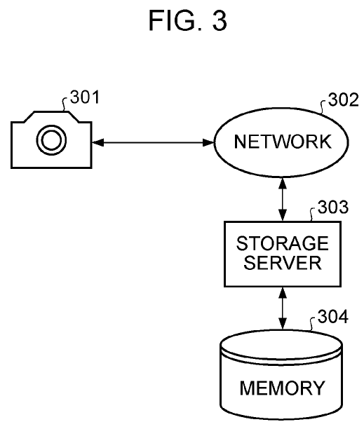

A structure of an example image pickup apparatus 301 serving as a moving image reproducing apparatus according to a first embodiment of the present invention will be described with reference to FIGS. 1 and 3. Referring to FIG. 3, the image pickup apparatus 301 may be a digital camera configured to obtain moving image data. The image pickup apparatus 301 is connected to a storage server 303 via a network 302. The storage server 303 includes a memory 304 having a large capacity.

FIG. 1 is a block diagram showing an internal structure of the image pickup apparatus 301.

Referring to FIG. 1, an image-capturing unit 101 includes an image pickup element operable to obtain moving image data. An encoding unit 102 encodes the obtained moving image data using an encoding scheme. In the present embodiment, the encoding scheme may be, but not be limited to, Moving Picture Experts Group 2 (MPEG-2). Any other encoding scheme such as Motion Joint Photographic Experts Group (M-JPEG) or H.264 may be used to perform encoding. Alternatively, the moving image data may be output directly without being encoded.

A storage control unit 103 stores a portion of the moving image data in a memory 104 according to an instruction given from a storage capacity detection unit 105. The memory 104 is a memory that stores moving image data. The memory 104 may be a removable storage medium or a built-in memory.

A transfer unit 106 transfers the moving image data to the storage server 303, which is an external storage device, via the network 302. The moving image data transferred to the storage server 303 and the moving image data stored in the memory 104 are associated with each other by, for example, adding the same identifier. A reproduction control unit 108 reproduces the moving image data in order according to time stamp information added to a head of each group of pictures (GOP) of the moving image data.

A receiving unit 107 receives moving image data transmitted from the storage server 303 via the network 302. The receiving unit 107 includes a receiving buffer memory configured to temporarily hold the moving image data transmitted from the storage server 303.

In response to a reproduction instruction given from the instruction unit, the reproduction control unit 108 reads moving image data from the memory 104. The reproduction control unit 108 further instructs the storage server 303 to read moving image data having the same identifier as that of the portion of the moving image data, and receives the moving image data through the receiving unit 107. The reproduction control unit 108 performs a decoding process on the moving image data stored in the memory 104 and then the moving image data obtained through the receiving unit 107.

The storage control unit 103, a storage capacity detection unit 105, the transfer unit 106, the receiving unit 107, and the reproduction control unit 108 are constructed in hardware by using a control device (central processing unit (CPU)) and other suitable devices. The control device is operated according to a program stored in a computer-readable storage medium such as a random access memory (RAM).

A decoding unit 109 decodes the moving image data output from the reproduction control unit 108. A display unit 110 may be a monitor configured to reproduce the decoded data to display a moving image.

A selection unit 111 selects moving image data to be transferred by the transfer unit 106 on the basis of a total reproduction time of the moving image data reproduced under the control of the reproduction control unit 108, and outputs information regarding the selected moving image data to the transfer unit 106.

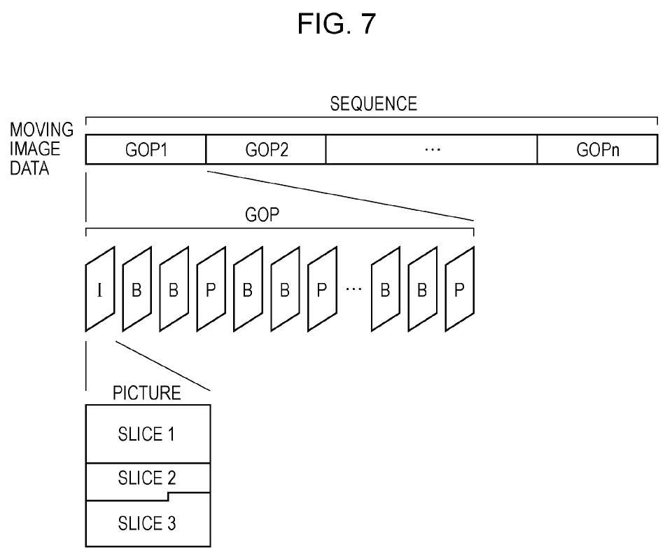

Elements constituting moving image data will now be described. As shown in FIG. 7, moving image data has a structure having layers of sequence, GOP, picture, and slice. The sequence layer is composed of a sequence of GOPs obtained from the start to the end of photographing. The GOP layer lies beneath the sequence layer, and is composed of a plurality of pictures including, referring to FIG. 7, an intra-frame coded picture (I-picture), forward predictive-coded pictures (P-pictures), and bidirectionally predictive-coded pictures (B-pictures). In general, a GOP is a sequence of pictures that is segmented by every I-picture, and is a unit by which the moving image data can be randomly accessed. The picture layer is composed of one or more slices. In H.264, the moving image data structure layer called GOP does not exist. Instead, as shown in FIG. 6, it is assumed that a sequence of pictures that is segmented by every instantaneous decoding refresh (IDR) picture is regarded as a GOP.

Next, a moving image data storage control process of the image pickup apparatus 301 according to the present embodiment will be described in detail.

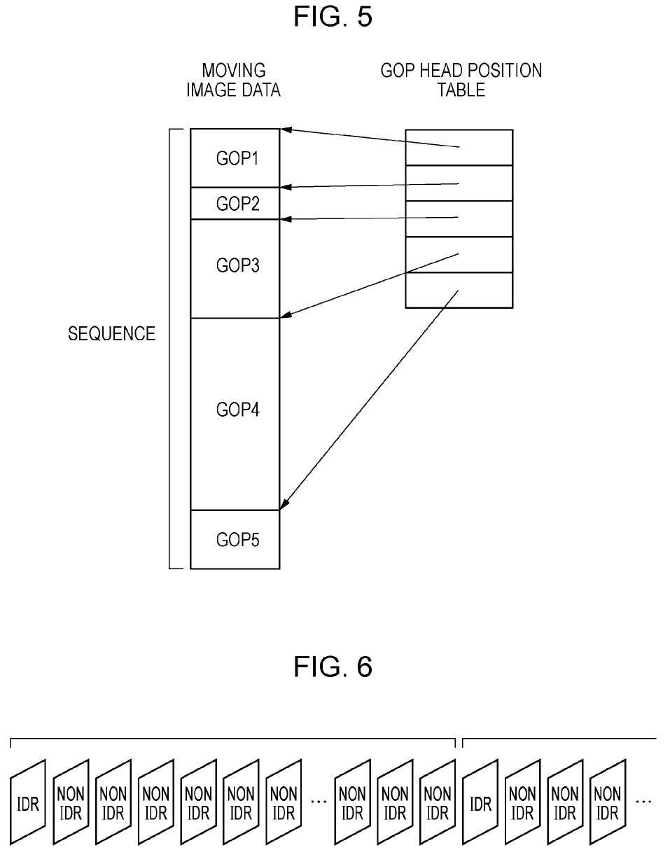

Upon receiving an instruction from a user through an input device (not shown), the storage control unit 103 stores the moving image data output from the encoding unit 102 into the memory 104. The storage control unit 103 also stores information regarding head positions of the GOPs constituting the stored moving image data sequence, such as that shown in FIG. 5, into the memory 104.

Therefore, though the transfer unit 106 stops transferring on the way, the storage server 303 could store the second half of the sequence and the memory 104 could store the first half of the sequence.

The storage control unit 103 may store the head positions of the GOP1, GOP2 . . . GOP5 constituting the sequence into the memory 104 after the completion of the series of sequence encoding processes of the moving image data. Alternatively, the storage control unit 103 may store information regarding head positions of individual pictures instead of GOPs into the memory 104.

The reproduction control unit 108 adds a reproduction time of moving image data to be reproduced in a sequence to a reproduction time of previously reproduced moving image data in the sequence to determine a total reproduction time of the sequence, and stores information regarding the total reproduction time into the memory 104. This process is executed for each of a plurality of sequences. The reproduction time of each sequence can be determined by the reproduction control unit 108 by referring to time stamp information added to moving image data to be reproduced in a sequence. The information regarding the total reproduction time is stored in the memory 104 as a table having a correspondence with identifiers of moving image data sequences.

The selection unit 111 refers to the table stored in the memory 104 from the last of GOP in a sequence to select a sequence having the shortest total reproduction time.

By the way, according to the step 202, the transfer unit 106 can send moving image data corresponding to the selected sequence to the storage server 303 until that the number of GOPs that have not been transferred has reached the pre-defined number. However, the reproduction time of encoded data left in the memory 104 can be assured because a certain number of GOPs from the head of a sequence are left in the memory 104. The reason is to assure the reproduction time during which a reduction in the imaging quality of the reproduced movie involved in transfer error does not occur.

And then, according to step 205, when the residual quantity of the memory capacity has not reached the pre-defined number, the movie coded data cannot be started to transfer. However, the transfer unit 106 can transfer the sequence captured to the storage server 303 regardless of any residual amount of the memory capacity.

And then, the transfer unit 106 of the image pickup apparatus 301 according to the present embodiment can transfer movie coded data to the storage server 303 not only by GOP but also by picture or slice.

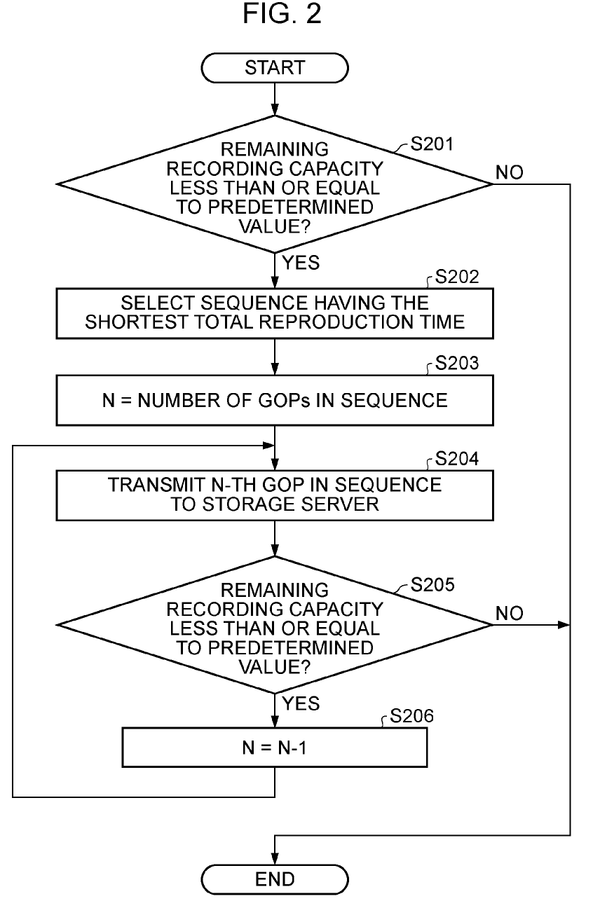

The transfer unit 106 performs a process shown in a flowchart of FIG. 2 on the basis of the remaining capacity of the memory 104, which is obtained from the storage capacity detection unit 105, and information regarding the moving image sequence selected by the selection unit 111.

First, the transfer unit 106 determines whether or not the remaining storage capacity of the memory 104 is less than or equal to a predetermined value (step S201). If the remaining storage capacity of the memory 104 is not less than or equal to the predetermined value (NO in step S201), the process ends. If the remaining storage capacity of the memory 104 is less than or equal to the predetermined value (YES in step S201), the process proceeds to step S202.

The transfer unit 106 selects a moving image data sequence having a low reproduction probability from among a plurality of moving image data sequences stored in the memory 104 (step S202). The moving image data sequence having a low reproduction probability, as used herein, refers to a sequence having the shortest total reproduction time. The selection unit 111 may select a moving image data sequence according to the total reproduction time after a specified time.

Then, the transfer unit 106 sets the number of GOPs constituting the selected moving image data sequence to a variable N (step S203). Then, the transfer unit 106 reads the N-th encoded GOP data in the sequence according to GOP head position information (see FIG. 5) stored by the storage control unit 103, and transfers the read data to the storage server 303 (step S204). The transferred encoded GOP data is deleted from the memory 104. Since the variable N is equal to the number of GOPs constituting the selected moving image data sequence, the last GOP in the sequence is transmitted.

Then, the storage control unit 103 determiners whether or not the remaining storage capacity is less than or equal to the predetermined value (step S205). If the remaining storage capacity is not less than or equal to the predetermined value (NO in step S205), the process ends. If the remaining storage capacity is less than or equal to the predetermined value (YES in step S205), the process proceeds to step S206. The transfer unit 106 decrements the value of the variable N by one (step S206), and executes the processing of steps S204 and S205 again.

In a case where an instruction to terminate the transfer is given from the user through the input device during the process described above, if the transmission of a GOP is in progress, the transfer unit 106 ends the process after transferring all data of that GOP to the storage server 303. Otherwise, the transfer unit 106 immediately ends the process.

The process described above is performed by the transfer unit 106 to select image data corresponding to a sequence having the lowest reproduction probability. Among the moving image data stored in the memory 104, moving image data corresponding to the selected sequence is transferred to the external storage server 303. Therefore, the reproduction process can be efficiently performed and the communication load can be reduced.

All moving image data corresponding to the sequence selected in step S202 may be transferred to the external storage server 303.

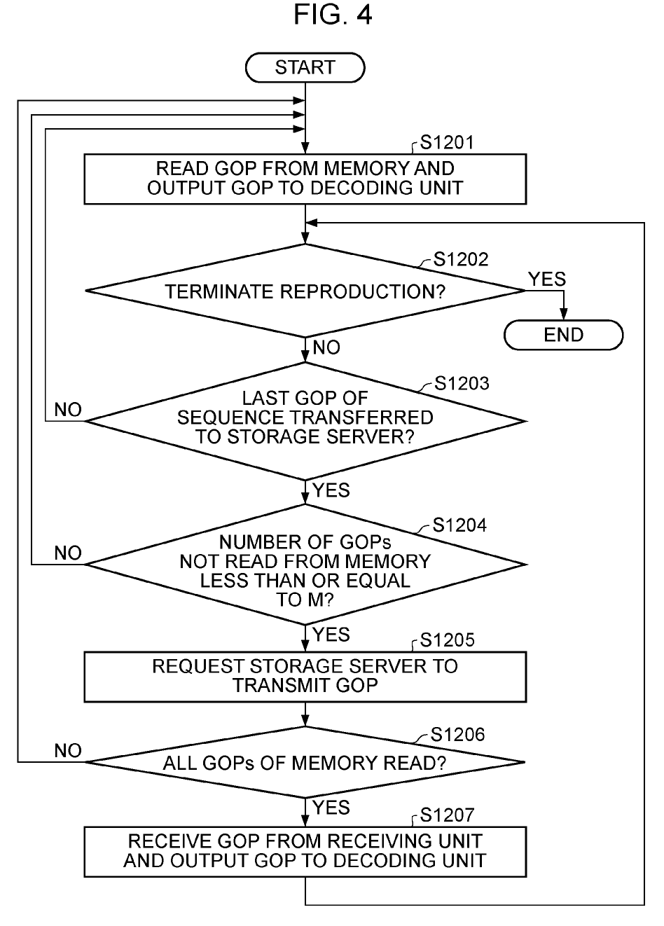

Next, the operation of the image pickup apparatus 301 according to the present embodiment for reproducing moving image data will be described with reference to a flowchart shown in FIG. 4.

When a moving image data sequence is selected in response to an instruction signal input from a user through the input device and an instruction to reproduce the sequence is given, the reproduction control unit 108 reads GOPs constituting the corresponding sequence from the memory 104 in order of reproduction. Then, the read GOPs are decoded in order by the decoding unit 109 (step S1201).

Then, the reproduction control unit 108 determines whether or not the reproduction process is to be terminated (step S1202). Specifically, when a condition that all the GOPs constituting the sequence have been decoded by the decoding unit 109 or that an instruction has been given from the user to interrupt the reproduction process is satisfied, the reproduction control unit 108 ends the process.

If the reproduction process is to be terminated (YES in step S1202), the reproduction control unit 108 ends the series of flowchart steps. Otherwise (NO in step S1202), the reproduction control unit 108 determines whether or not the last GOP of the sequence has been transferred to the storage server 303 (step S1203).

If the last moving image data (GOP) of the sequence has not been transferred to the storage server 303 (NO in step S1203), the reproduction control unit 108 performs the processing of step S1201 again. Otherwise (YES in step S1203), the reproduction control unit 108 determines whether or not the number of GOPs that has not been read from the memory 104 is less than or equal to a value M (step S1204).

The value M may be specifically determined on the basis of, for example, the number of GOPs that are decoded for a period of time from when a transmission request is output to the storage server 303 to when the receiving unit 107 receives moving image data (one GOP data item). Alternatively, the value M may be determined on the basis of the capacity of the receiving buffer memory (not shown in FIG. 1). Alternatively, the value M may be equal to the number of GOPs constituting the sequence. In this case, the reproduction control unit 108 reads the GOPs of the sequence from the memory 104, starting from the first GOP in the sequence, and outputs a transmission request to the storage server 303.

If the number of GOPs, which are moving image data that has not been read from the memory 104, is not less than or equal to the value M (NO in step S1204), the reproduction control unit 108 performs the processing of step S1201 again. Otherwise (YES in step S1204), the reproduction control unit 108 requests the storage server 303 to transmit GOPs, which are moving image data (step S1205).

Upon receiving the transmission request from the image pickup apparatus 301, the storage server 303 transmits GOPs, which are moving image data stored in the memory 304, in order starting from a GOP to be reproduced first. For example, in a case where a sequence is composed of GOPs 1 to 10 and moving image data of the GOPs 5 to 10 is stored in the memory 304, the GOPs are transmitted in order starting from the GOP 5.

The reproduction control unit 108 determines whether or not all the GOPs, which are moving image data stored in the memory 104, have been read (step S1206). If all the GOPs have not yet been read (NO in step S1206), the reproduction control unit 108 performs the processing of step S1201 again. If all the GOPs have been read from the memory 104 (YES in step S1206), the reproduction control unit 108 receives the GOPs through the receiving unit 107, and causes the decoding unit 109 to decode the GOPs (step S1207). Then, the reproduction control unit 108 performs the processing of step S1202 and subsequent steps again.

The reproduction control unit 108 of the image pickup apparatus 301 of the present embodiment may be configured to read moving image data on a picture-by-picture basis or a slice-by-slice basis or issue a transmission request on a picture-by-picture basis or a slice-by-slice basis.

Accordingly, the image pickup apparatus 301 of the present embodiment transfers moving image data stored in the built-in memory 104 to the storage server 303 in order starting from moving image data having a short total reproduction time. This can increase the remaining capacity of the memory 104, and can extend a photographing time. In addition, a delay involved in reproducing image data can be reduced as much as possible.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-267997 filed Oct. 15, 2007, which is hereby incorporated by reference herein in its entirety.

What is claimed is:

1. A moving image reproducing apparatus comprising:
a reproduction control unit configured to control reproduction of image data stored in a memory; and
a transfer unit configured to transfer image data corresponding to a sequence having a short total reproduction time to an external storage device, the sequence being reproduced by the reproduction control unit.

2. The moving image reproducing apparatus according to claim 1, wherein the transfer unit transfers the image data corresponding to the sequence having a short total reproduction time to the external storage device in order starting from moving image data to be reproduced last.

3. The moving image reproducing apparatus according to claim 1, wherein the transfer unit transfers image data corresponding to a sequence having a short reproduction time after a specified time to the external storage device.

4. A method for processing moving image data using a moving image reproducing apparatus, the method comprising:
controlling reproduction of image data stored in a memory of the image reproducing apparatus; and
transferring moving image data corresponding to a sequence having a short total reproduction time to an external storage device, the sequence being reproduced in the controlling reproduction step.

5. A computer readable medium containing computer-executable instructions for processing moving image data using a moving image reproducing apparatus, the medium comprising:
computer-executable instructions for controlling reproduction of image data stored in a memory of the image reproducing apparatus; and
computer-executable instructions for transferring moving image data corresponding to a sequence having a short total reproduction time to an external storage device, the sequence being reproduced in the controlling reproduction step.
